(19) United States
(12) Patent Application Publication
(10) Pub. No.: US 2022/0392170 A1
(43) Pub. Date: Dec. 8, 2022

(54) Interactive Display Devices in Extended Reality Environments

(71) Applicant: Citrix Systems, Inc., Fort Lauderdale, FL (US)

(72) Inventor: Manbinder Pal Singh, Coral Springs, FL (US)

(21) Appl. No.: 17/340,170

(22) Filed: Jun. 7, 2021

(51) Int. Cl. G06T 19/00; G06N 20/00; G06F 3/0481; G06F 3/01

(52) U.S. Cl. CPC G06T 19/006; G06N 20/00; G06F 3/04815; G06F 3/017

(57) ABSTRACT

Methods and systems for enabling interaction with physical display devices in an extended reality (XR) environment are described herein. A computing device may send, to an XR device, XR environment information for display of an XR environment on a display of an XR device. The computing device may receive one or more images originating from one or more cameras of the XR device. For example, the one or more images might be of a physical environment around the XR device. The computing device may detect one or more portions of a display device depicted in the one or more images. The display device may display content from a second computing device. The computing device may detect input, in the XR environment, associated with the content and transmit that input to the second computing device. Such input might comprise, for example, gestures.

### FIELD

Aspects described herein generally relate to extended reality (XR), such as virtual reality, augmented reality, and/or mixed reality, and hardware and software related thereto. More specifically, one or more aspects describe herein provide ways in which a user of an XR environment can interact with content displayed on real-world display devices, such as monitors and televisions.

### BACKGROUND

Display devices, such as liquid crystal displays (LCDs), are used in a wide variety of circumstances. For example, a household living room might have multiple different display devices, such as a television, one or more smartphones, one or more laptops, display screens for appliances (e.g., air conditioning systems), and the like, each displaying different content from different computing devices (e.g., cable set-top boxes, personal computers, mobile devices). That said, the computing devices providing output to these display devices might be controllable in a wide variety of different ways. For example, smartphones are often operated using touchscreens, whereas most televisions are still exclusively controlled using television remotes, which is tedious and cumbersome.

### SUMMARY

The following presents a simplified summary of various aspects described herein. This summary is not an extensive overview, and is not intended to identify required or critical elements or to delineate the scope of the claims. The following summary merely presents some concepts in a simplified form as an introductory prelude to the more detailed description provided below.

XR display devices provide users many different ways to interact with an XR environment (e.g., a virtual reality environment, an augmented reality environment, and/or a mixed reality environment). For example, XR display devices often allow users to, in conjunction with motion sensitive devices such as motion controllers, provide gesture input, such as waving their hands, pointing at real and/or virtual objects, or the like. Additionally and/or alternatively, such XR display devices also allow users to provide input based on their gaze (e.g., by looking at real and/or virtual objects). With that said, such input methods have previously only been used to interact with virtual objects presented in an XR environment. For example, an augmented reality environment might allow a user to interact with a virtual control panel, but generally does not account for user interactions with real-world objects.

To overcome limitations in the prior art described above, and to overcome other limitations that will be apparent upon reading and understanding the present specification, aspects described herein are directed towards leveraging XR environment input to provide input for content displayed by real-world display devices, such as monitors, televisions, and the like. In this manner, a user might use a non-touchscreen display device as if it were a touchscreen display device, and/or might use gesture input to control content on a conventional laptop computer. For example, as will be described herein, augmented reality glasses might be used to turn a desktop computer monitor into a virtual touch screen such that inputs by a user in an XR environment (e.g., gestures such as pointing to a portion of the screen) are translated into input for content displayed by the monitor (e.g., a mouse click on a corresponding portion of the screen).

As will be described further herein, a computing device may send, to an XR device, XR environment information for display of an XR environment on a display of an XR device. An XR environment might comprise, for example, an augmented reality environment, a virtual reality environment, a mixed reality environment, or the like. The XR environment information might comprise content for display as part of the XR environment, such as one or more virtual objects. The computing device may receive one or more images originating from one or more cameras of the XR device. For example, the one or more images might be of a physical environment around the XR device. The computing device may detect one or more portions of a display device depicted in the one or more images. The display device may display content from a second computing device. The computing device may detect input, in the XR environment, associated with the content. For example, the computing device might detect a gesture, a pointing motion, or the like. The computing device may transmit that input to the second computing device.

These and additional aspects will be appreciated with the benefit of the disclosures discussed in further detail below.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative extended reality (XR) device.

FIG. 3 depicts an XR device connected to a server via a network.

FIG. 4 depicts a physical environment about an XR device.

FIG. 5 depicts a flow chart for receiving input in an XR environment and providing that input to a different computing device.

FIG. 6 depicts a bounding box for a display device.

FIG. 7 depicts a table indicating correlations between gestures in an XR environment and inputs for different applications.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein are directed towards using XR devices to allow users to interact with real-world display devices. Many real-world display devices, such as monitors, tablets, and televisions, are fairly limited in the manner in which they permit input to be provided. For example, a traditional desktop computer might be capable of receiving input via a mouse and keyboard (and/or microphones/cameras), but not via user gestures, a user touching a portion of a display screen, a user pointing (using their finger and/or hand), or the like. As a particular example, few desktop computers have touchscreen monitors, meaning that those desktop computers are typically limited to input via a keyboard and/or mouse. These input methods are, in many circumstances, not only quite limiting, but also can be difficult to use while in an XR environment. For example, a user in an augmented reality environment might use motion sensitive devices to interact with the augmented reality environment but, because the might be required to hold the motion sensitive devices in each hand to interact in the augmented reality environment, they might not be able to simultaneously use a mouse and keyboard as, after all, their hands are otherwise occupied.

Aspects described herein allow for users to, via input in an XR environment, control content displayed on display devices, such as monitors, televisions, and the like. For example, such a system allows users to, using input in an augmented reality environment, use touches or gestures to control content on monitors that display output from computing devices that are otherwise not configured to receive touch and/or gesture input. In practice, this may allow users to provide a wider range of inputs than might be ordinarily configured for content displayed by a real-life display device. For example, a typical desktop computer might not be equipped with motion controls, but aspects described herein would allow a user to use a gesture (e.g., rotating their wrist) to control a user interface element (e.g., a volume knob on a media player executing on the desktop computer). This process might be accomplished by detecting real-life display devices and transmitting interactions, in the XR device, intended for that display device to a computing device that causes display of content on the display device. In practice, such a system has immense utility in circumstances where users might want to avoid using conventional input methods (such as a keyboard, mouse, television remote control, or the like). For example, in a factory, the process described herein may allow workers to interact with displayed content without removing protective gloves.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “connected,” “coupled,” and similar terms, is meant to include both direct and indirect connecting and coupling.

Computing Architecture

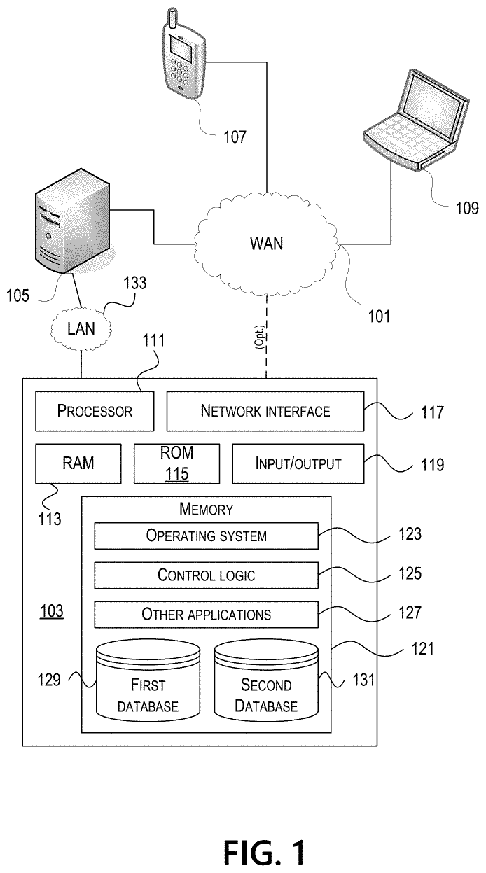

Computer software, hardware, and networks may be utilized in a variety of different system environments, including standalone, networked, remote-access (also known as remote desktop), virtualized, and/or cloud-based environments, among others. FIG. 1 illustrates one example of a system architecture and data processing device that may be used to implement one or more illustrative aspects described herein in a standalone and/or networked environment. Various network nodes 103, 105, 107, and 109 may be interconnected via a wide area network (WAN) 101, such as the Internet. Other networks may also or alternatively be used, including private intranets, corporate networks, local area networks (LAN), metropolitan area networks (MAN), wireless networks, personal networks (PAN), and the like. Network 101 is for illustration purposes and may be replaced with fewer or additional computer networks. A local area network 133 may have one or more of any known LAN topology and may use one or more of a variety of different protocols, such as Ethernet. Devices 103, 105, 107, and 109 and other devices (not shown) may be connected to one or more of the networks via twisted pair wires, coaxial cable, fiber optics, radio waves, or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects describe herein. Data server 103 may be connected to web server 105 through which users interact with and obtain data as requested. Alternatively, data server 103 may act as a web server itself and be directly connected to the Internet. Data server 103 may be connected to web server 105 through the local area network 133, the wide area network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the data server 103. Data server 103 may further include random access memory (RAM) 113, read only memory (ROM) 115, network interface 117, input/output interfaces 119 (e.g., keyboard, mouse, display, printer, etc.), and memory 121. Input/output (I/O) 119 may include a variety of interface units and drives for reading, writing, displaying, and/or printing data or files. Memory 121 may further store operating system software 123 for controlling overall operation of the data processing device 103, control logic 125 for instructing data server 103 to perform aspects described herein, and other application software 127 providing secondary, support, and/or other functionality which may or might not be used in conjunction with aspects described herein. The control logic 125 may also be referred to herein as the data server software 125. Functionality of the data server software 125 may refer to operations or decisions made automatically based on rules coded into the control logic 125, made manually by a user providing input into the system, and/or a combination of automatic processing based on user input (e.g., queries, data updates, etc.).

Memory 121 may also store data used in performance of one or more aspects described herein, including a first database 129 and a second database 131. In some embodiments, the first database 129 may include the second database 131 (e.g., as a separate table, report, etc.). That is, the information can be stored in a single database, or separated into different logical, virtual, or physical databases, depending on system design. Devices 105, 107, and 109 may have similar or different architecture as described with respect to device 103. Those of skill in the art will appreciate that the functionality of data processing device 103 (or device 105, 107, or 109) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HyperText Markup Language (HTML) or Extensible Markup Language (XML). The computer executable instructions may be stored on a computer readable medium such as a nonvolatile storage device. Any suitable computer readable storage media may be utilized, including hard disks, CD-ROMs, optical storage devices, magnetic storage devices, solid state storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

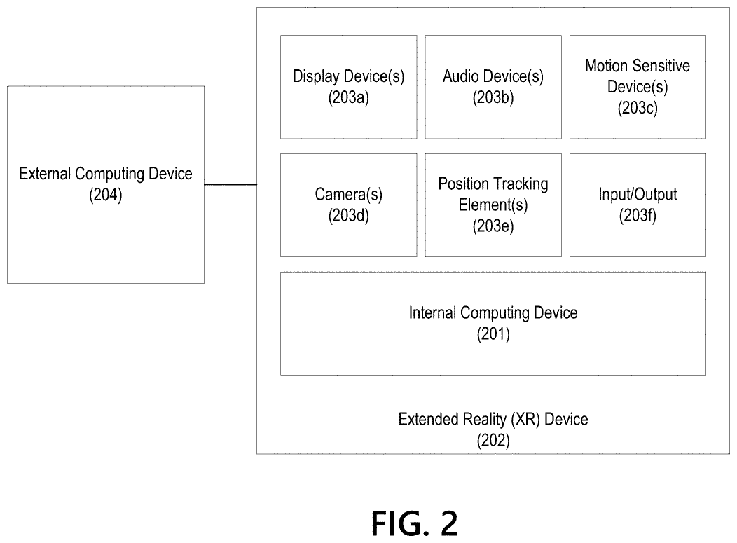

FIG. 2 depicts an example of an XR device 202. The XR device 202 may be configured to provide a XR environment (e.g., a virtual reality (VR), augmented reality (AR), and/or mixed reality (MR) environment). The XR device 202 may be communicatively connected to a external computing device 204, which may be the same or similar as one or more of the devices 103, 105, 107, and 109. The XR device 202 may comprise a plurality of different elements, such as display devices 203a, audio devices 203b, motion sensitive devices 203c, cameras 203d, position tracking elements 203e, and input/output 203f Such elements may additionally and/or alternatively be referred to as sensors. Other such elements, not shown, may include in-ear electroencephalographic (EEG) and/or heart rate variability (HRV) measuring devices, scalp and/or forehead-based EEG and/or HRV measurement devices, eye-tracking devices (e.g., using infrared), or the like. The XR device 202 may further comprise a internal computing device 201, which may be the same or similar as the devices 103, 105, 107, and 109. Not all elements shown in FIG. 2 need to be present for operation of the XR device 202. For example, the XR device 202 might lack a internal computing device 201, such that the external computing device 204 may directly interface with the display devices 203a, the audio devices 203b, the motion sensitive devices 203c, the cameras 203d, the position tracking elements 203e, and/or the input/output 203f to provide an XR environment. As another example, the internal computing device 201 may be sufficiently powerful enough such that the external computing device 204 may be omitted. Though the internal computing device 201 and external computing device 204 use the terms internal and external for the purposes of illustration in FIG. 2, these devices need not be, for example, located within or outside of housing of the XR device 202. For example, the external device 204 may be physically mounted to the XR device 202, a user of the XR device 202, or the like. As another example, the internal device 201 might be physically distant from other elements of the XR device 202 and, e.g., connected to those elements by a long cable.

The external computing device 204 and/or the internal computing device 201 need not have any particular processing power or functionality to provide an XR environment. The external computing device 204 and/or the internal computing device 201 may comprise, for example, relatively underpowered processors which provide rudimentary video and/or audio. Alternatively, the external computing device 204 and/or the internal computing device 201 may, for example, comprise relatively powerful processors which provide highly realistic video and/or audio. As such, the external computing device 204 and/or the internal computing device 201 may have varying levels of processing power.

The XR device 202 may provide a VR, AR, and/or MR environment to the user. In general, VR environments provide an entirely virtual world, whereas AR and/or MR environments mix elements in the real world and the virtual world. The XR device 202 may be a device specifically configured to provide an XR environment (e.g., a VR headset), or may be a combination of devices (e.g., a smartphone inserted into a headset) which, when operated in a particular manner, provides an XR environment. The XR device 202 may be said to be untethered at least in part because it may lack a physical connection to another device (and, e.g., may be battery powered). If the XR device 202 is connected to another device (e.g., the external computing device 204, a power source, or the like), it may be said to be tethered. Examples of the XR device 202 may include the VALVE INDEX VR device developed by Valve Corporation of Bellevue, Wash., the OCULUS QUEST VR device sold by Facebook Technologies, LLC of Menlo Park, Calif., and the HTC VIVE VR device sold by HTC Corporation of New Taipei City, Taiwan. Examples of the XR device 202 may also include smartphones which may be placed into a headset for VR purposes, such as the GEAR VR product sold by Samsung Group of Seoul, South Korea. Examples of the XR device 202 may also include the AR headsets sold by Magic Leap, Inc. of Plantation, Fla., the HOLOLENS MR headsets sold by Microsoft Corporation of Redmond, Wash., and NREAL LIGHT headsets sold by Hangzhou Tairuo Technology Co., Ltd. of Beijing, China, among others. Examples of the XR device 202 may also include audio-based devices, such as the ECHO FRAMES sold by Amazon, Inc. of Seattle, Wash. All such VR devices may have different specifications. For example, some VR devices may have cameras, whereas others might not. These are merely examples, and other AR/VR systems may also or alternatively be used.

The external computing device 204 may provide all or portions of an XR environment to the XR device 202, e.g., as used by a tethered OCULUS RIFT. For example, the external computing device 204 may provide a video data stream to the XR device 202 that, when displayed by the XR device 202 (e.g., through the display devices 203a), shows a virtual world. Such a configuration may be advantageous where the XR device 202 (e.g., the internal computing device 201 that is part of the XR device 202) is not powerful enough to display a full XR environment. The external computing device 204 need not be present for the XR device 202 to provide an XR environment. For example, where the internal computing device 201 is sufficiently powerful, the external computing device 204 may be omitted, e.g., an untethered OCULUS QUEST.

The display devices 203a may be any devices configured to display all or portions of an XR environment. Such display devices 203a may comprise, for example, flat panel displays, such as one or more liquid-crystal display (LCD) panels. The display devices 203a may be the same or similar as the display 106. The display devices 203a may be singular or plural, and may be configured to display different images to different eyes of a user. For example, the display devices 203a may comprise one or more display devices coupled with lenses (e.g., Fresnel lenses) which separate all or portions of the displays for viewing by different eyes of a user.

The audio devices 203b may be any devices which may receive and/or output audio associated with an XR environment. For example, the audio devices 203b may comprise speakers which direct audio towards the ears of a user. As another example, the audio devices 203b may comprise one or more microphones which receive voice input from a user. The audio devices 203b may be used to provide an audio-based XR environment to a user of the XR device 202.

The motion sensitive devices 203c may be any elements which receive input related to the motion of a user of the XR device 202. For example, the motion sensitive devices 203c may comprise one or more accelerometers which may determine when a user of the XR device 202 is moving (e.g., leaning, moving forward, moving backwards, turning, or the like). Three dimensional accelerometers and/or gyroscopes may be used to determine full range of motion of the XR device 202. Optional external facing cameras 203d may be used for 3D orientation as well. The motion sensitive devices 203c may permit the XR device 202 to present an XR environment which changes based on the motion of a user. The motion sensitive devices 203c might additionally and/or alternatively comprise motion controllers or other similar devices which might be moved by a user to indicate input. As such, the motion sensitive devices 203c may be wholly or partially separate from the XR device 202, and may communicate via the input/output 203f.

The cameras 203d may be used to aid in the safety of the user as well as the presentation of an XR environment. The cameras 203d may be configured to capture images of one or more portions of an environment around the XR device 202. The cameras 203d may be used to monitor the surroundings of a user so as to avoid the user inadvertently contacting elements (e.g., walls) in the real world. The cameras 203d may additionally and/or alternatively monitor the user (e.g., the eyes of the user, the focus of the user's eyes, the pupil dilation of the user, or the like) to determine which elements of an XR environment to render, the movement of the user in such an environment, or the like. As such, one or more of the cameras 203d may be pointed towards eyes of a user, whereas one or more of the cameras 203d may be pointed outward towards an environment around the XR device 202. For example, the XR device 202 may have multiple outward-facing cameras that may capture images, from different perspectives, of an environment surrounding a user of the XR device 202.

The position tracking elements 203e may be any elements configured to aid in the tracking of the position and/or movement of the XR device 202. The position tracking elements 203e may be all or portions of a system of infrared emitters which, when monitored by a sensor, indicate the position of the XR device 202 (e.g., the position of the XR device 202 in a room). The position tracking elements 203e may be configured to permit “inside-out” tracking, where the XR device 202 tracks the position of one or more elements (e.g., the XR device 202 itself, a user's hands, external controllers, or the like) or “outside-in” tracking, where external devices aid in tracking the position of the one or more elements.

The input/output 203f may be configured to receive and transmit data associated with an XR environment. For example, the input/output 203f may be configured to communicate data associated with movement of a user to the external computing device 204. As another example, the input/output 203f may be configured to receive information from other users of in multiplayer XR environments.

The internal computing device 201 and/or the external computing device 204 may be configured to provide, via the display devices 203a, the audio devices 203b, the motion sensitive devices 203c, the cameras 203d, the position tracking elements 203e, and/or the input/output 203f, the XR environment. The internal computing device 201 may comprise one or more processors (e.g., a graphics processor), storage (e.g., that stores virtual reality programs), or the like. In general, the internal computing device 201 may be powerful enough to provide the XR environment without using the external computing device 204, such that the external computing device 204 need not be required and need not be connected to the XR device 202. In other configurations, the internal computing device 201 and the external computing device 204 may work in tandem to provide the XR environment. In other configurations, the XR device 202 might not have the internal computing device 201, such that the external computing device 204 interfaces with the display devices 203a, the audio devices 203b, the motion sensitive devices 203c, the cameras 203d, the position tracking elements 203e, and/or the input/output 203f directly.

The above-identified elements of the XR device 202 are merely examples. The XR device 202 may have more or similar elements. For example, the XR device 202 may include in-ear EEG and/or HRV measuring devices, scalp and/or forehead-based EEG and/or HRV measurement devices, eye-tracking devices (e.g., using cameras directed at users' eyes, pupil tracking, infrared), or the like.

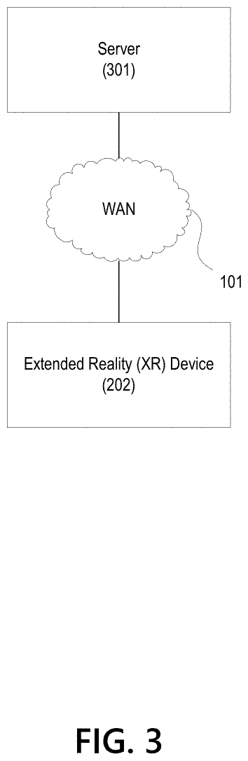

FIG. 3 shows the XR device 202 connected, via the network 101, to a server 301. The server 301 may be a computing device the same or similar as the devices 103, 105, 107, and 109. Additionally and/or alternatively, the server 301 may be the same or similar as the external computing device 204. The server 301 may be configured to generate all or portions of an XR environment displayed by the XR device 202. For example, the XR device 202 may receive, via the network 101, data (e.g., a video stream) from the server 301, and the data may comprise a virtual object which may be displayed in an XR environment. Advantageously, the server 301 may have superior computing power as compared to the XR device 202, such that content generated by the server 301 (e.g., virtual objects rendered by the server 301) may have a superior graphical quality as compared to the XR device 202.

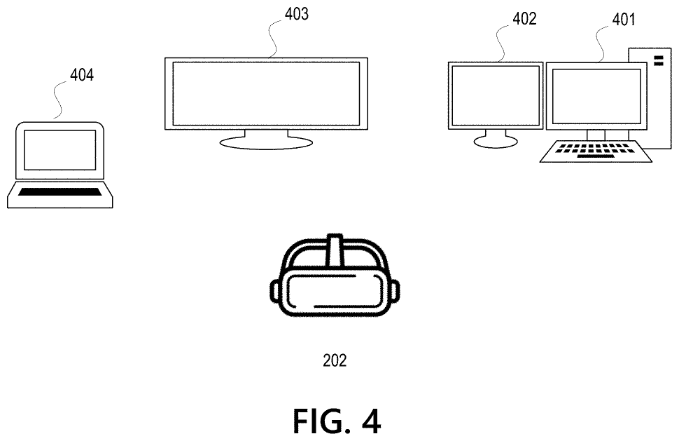

FIG. 4 depicts a physical environment around the XR device 202. Depicted in FIG. 4 are four different display devices: a first monitor 401, a second monitor 402, a television 403, and a laptop screen 404. All such display devices may be referred to as physical display devices or real display devices in that they exist in a real-world physical environment about the XR device 202, and might not necessarily be displayed in any sort of XR environment.

Display devices, such as the first monitor 401, the second monitor 402, the television 403, and the laptop screen 404, may display content generated by one or more computing devices. For example, the first monitor 401 and the second monitor 402 display different portions of a desktop environment generated by a desktop computer. As another example, the television 403 might display video content generated by a set-top box, a video game console, or the like.

The content displayed by display devices might support only a limited set of input methods. For example, the laptop screen 404 might display content that can be controlled using a touchpad or a keyboard, but not through touch input and/or gestures. As another example, the television 403 might provide a rudimentary user interface which might only be controllable using a remote control. Such limitations can become frustrating for a user, particularly where the user has limited mobility or control options. For example, in an industrial environment, a user might wear thick protective gloves which make it difficult to control a mouse and/or keyboard. As another example, a user of the XR device 202 might use handheld motion controllers to cause input in the XR environment. As such, the user's hands might be occupied such that they might not be able to use a laptop touchpad or keyboard comfortably. This can be particularly frustrating to users where such input is necessitated by the XR environment. For example, if the XR device 202 crashes while displaying an XR environment, a user might need to use a desktop computer (e.g., the desktop computer displaying content on the first monitor 401 and the second monitor 402) to restart the XR environment. But restarting that XR environment might entail use of a keyboard and mouse. As such, the user might become frustrated as they must remove the XR device 202 and put down any motion controllers they were using in order to use a keyboard and/or mouse.

Implementing Display Device Interactivity in XR Environments

Having discussed several examples of computing devices, display devices, XR devices which may be used to implement some aspects as discussed further below, discussion will now turn to remote rendering of reflections on objects in XR environments.

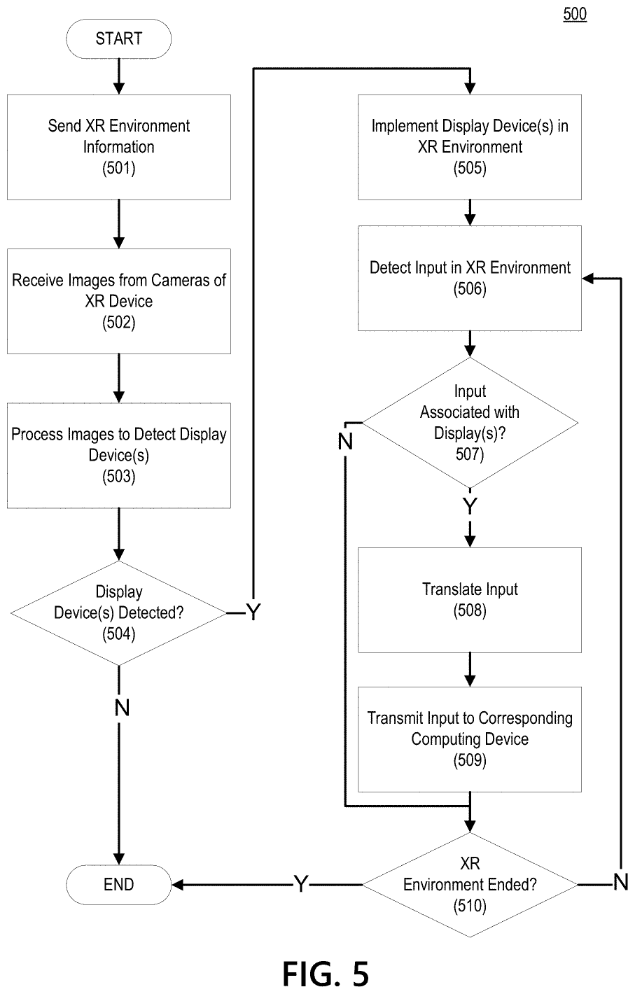

FIG. 5 depicts a flow chart depicting steps of a method 500 for implementing display device interactivity in XR environments. The steps shown in FIG. 5 may be performed by all or portions of a computing device, such as the external computing device 204, the internal computing device 201, the server 301, or the like. A computing device comprising one or more processors and memory storing instructions may be configured such that the instructions, when executed, cause performance of one or more of the steps of FIG. 5. The steps depicted in FIG. 5 are illustrative, and may be rearranged or omitted as desired. For example, step 508 (which relates to translating input, as will be described below) may be omitted in certain circumstances. As another example, numerous steps might be performed between steps 505 and 506 because, for example, a user might enjoy an XR environment for a long time before providing any sort of input.

In step 501, the computing device may send XR environment information. XR environment information may comprise any form of data which enables display of an XR environment by an XR device, such as the XR device 202. For example, the XR environment information may be a video stream (e.g., from the external computing device 204 and/or the server 301) which may be received and displayed by the XR device 202. As another example, the XR environment information may be application data which, when executed by a computing device (e.g., the internal computing device 201 that is part of the XR device 202), causes display of an XR environment. The XR environment data may be for a virtual reality environment, such that the XR environment data may occupy substantially all of a user's field of view, effectively replacing reality with a virtual reality. Additionally and/or alternatively, the XR environment data may be for an augmented reality and/or mixed reality environment, such that the data specifies portions of the user's field of view to be occupied by virtual objects and portions of the user's field of view that represent real-world objects (e.g., via video captured from the cameras 203d).

In step 502, the computing device may receive one or more images from cameras of the XR device. For example, the computing device may receive one or more images from the cameras 203d of the XR device 202. The one or more images may be frames of video content (e.g., three frames of video content), a single image, a series of images taken over a period of time (e.g., three images captured over a six-second period, effectively comprising a 0.5 frames per second video broken into discrete image files), or the like. The images need not be in any particular format. For example, the images might be conventional color images, such as might be captured by an RGB camera, and as saved as image files. Additionally and/or alternatively, the images might be part of a video stream. Additionally and/or alternatively, the images might capture positional data, such as capturing infrared data which might be used to locate real-world infrared sources. In the case of augmented and/or mixed reality environments, it might be desirable to capture video at a relatively high frame rate, as doing so may allow the XR environment to better emulate real life.

In step 503, the computing device may process the images received in step 502 to detect one or more portions of one or more display devices. The images received in step 502 might capture images of one or more display devices in a physical environment of a user. For example, the images might capture all or portions of the first monitor 401, the second monitor 402, the television 403, and the laptop screen 404. In this manner, the images might indicate a location, with respect to the XR device 202, of a display device. The entirety of a display device need not be captured in order for it to indicate the location of a display device: after all, capturing even a small corner of a display device might indicate the location of a display device in physical space.

As part of processing the images received in step 502 to detect the one or more portions of the one or more display devices, a location of the one or more display devices may be determined. The location might be in three-dimensional space, such that the location might correspond not only to where the one or more display devices are with respect to a user's field of view, but also how far those one or more display devices are from the user. In this manner, it might be possible to represent the display devices in an XR environment based on a comparison of the position of the XR device 202 as well as the position of one or more display devices. For example, based on the three-dimensional position of a real-life display device, a virtual display device might be generated at a corresponding location in the XR environment. As will be described further below, this location information may allow the computing device to determine, for example, which display device, of a plurality of display devices, input may be intended for. For example, by comparing the gaze of a user with the location information of a display, the computing device may be able to determine whether a user is looking at a particular display.

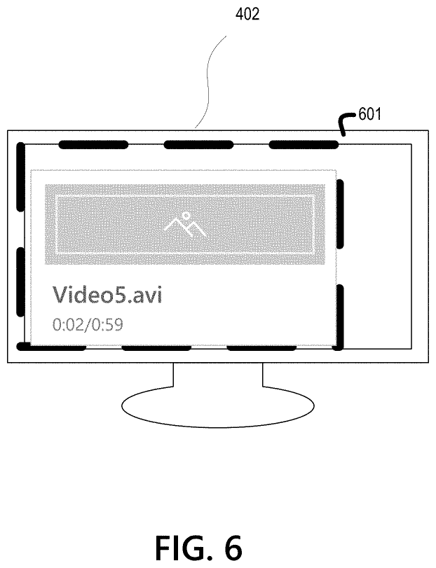

Detecting the one or more portions of the one or more display devices may comprise detecting, based on the one or more images, a bounding box corresponding to a location, in the one or more images, of the display device. A bounding box may correspond to an indication of the boundaries of a display device. For example, a bounding box may be drawn over a display device such that the four corners of the bounding box substantially correspond to the four corners of the display device. Because the one or more images might represent the one or more display devices from various perspectives, the bounding box need not be a perfect rectangle. For example, the first monitor 401 might be seen, by the XR device 202, from an angle, such that the bounding box may be a parallelogram, quadrilateral, or the like. An example of such a bounding box is discussed below with reference to FIG. 6.

Detecting the one or more portions of the one or more display devices may entail use of a machine learning algorithm. A machine learning model may be trained using training data that indicates locations of display devices in a plurality of different images. For example, the machine learning model might be provided data that comprises a plurality of different images and, for each image, data which indicates coordinates (e.g., for corners of bounding boxes) of one or more display devices in the corresponding image. The computing device may provide, to the trained machine learning model, the one or more images. In return, the computing device may receive, from the trained machine learning model, an indication of a predicted location of the display device. For example, the computing device may receive, from the trained machine learning model, coordinates for a bounding box that indicates a predicted location of the display device. As another example, the computing device may receive, from the trained machine learning model, a Boolean indication that a display device was detected, including an indication of a region of an image (e.g., top left, bottom right) where the display device is predicted to be located

In step 504, the computing device may determine whether one or more display devices were detected in the images processed in step 503. For example, the computing device may determine whether it identified a bounding box corresponding to the display device and/or received output, from a trained machine learning model, that indicated the presence of a display device. If not, then the method 500 ends. Otherwise, the method 500 proceeds to step 505.

In step 505, the computing device may implement the one or more display devices in the XR environment. Implementing the one or more display devices in the XR environment may comprise displaying a representation of the one or more display devices in the XR environment. For example, in the context of an augmented and/or mixed reality environment, the real-world display devices may be shown. This might be accomplished by displaying video, corresponding to the one or more display devices, captured by the cameras 203d. Additionally and/or alternatively, in the situation where the XR device 202 does not occupy all of the user's field of view, such as in the case of smart glasses, the XR device 202 may allow the user to see through a portion of the display to view the one or more display devices.

Implementing the one or more display devices in the XR environment need not comprise rendering a representation of the one or more display devices in the XR environment. In some circumstances (e.g., AR environments), portions of real-world environments may be displayed as part of the XR environment. In such a circumstance, the XR environment need not render additional content, as a user of the XR environment may be capable of viewing the one or more display devices in the XR environment. In this manner, and as will be described below, a user might be able to use gesture controls for a real-world display device via the XR environment. Indeed, the XR environment need not render any content (e.g., 2D or 3D content generated by a graphics engine), but might simply display a real-world environment captured by the cameras 203d.

Implementing the one or more display devices in the XR environment may comprise allowing the user to see content displayed by the display devices. For example, if the second monitor 402 is displaying video, then the XR device 202 may be configured to allow the user to view that content, through the second monitor 402, in the XR environment. Because the refresh rates of various display devices may differ in comparison to the framerate of the cameras 203d, the XR device 202 may modify the frame rate of the cameras 203d to substantially match that of the display devices to avoid the appearance of flicker. Where the XR device 202 displays a virtual representation of a real-world display device, the XR device 202 may use the cameras 203d to capture content displayed by the real-world display device, crop the content to fit a virtual display device, and cause the virtual display device to display the cropped content.

Implementing the one or more display devices in the XR environment may comprise implementing virtual versions of user interface elements displayed by the one or more display devices. For example, if the one or more display devices display a volume control slider, then the slider might be represented as a virtual slider in the XR environment, such that the user might push or pull the virtual slider to control volume. In this manner, small and/or unwieldy user interface elements designed to be displayed on a high-resolution monitor and/or designed to be controlled by a mouse can be translated into larger virtual interface elements which might be controlled using, for example, motion controllers, video game controllers, or the like.

In step 506, the computing device may detect input in the XR environment. Detecting input in the XR environment might comprise detecting any form of interaction by a user. Such interaction might be captured by the motion sensitive devices 203c, the cameras 203d, the position tracking elements 203e, and/or the input/output 203f of the XR device 202. For example, the motion sensitive devices 203c might track movement of a user's arms and/or hands, such that the interaction might comprise a gesture, a pointing motion, or the like. As another example, the position tracking elements 203e might track movement of a user in three dimensional space, such that the user moving from one position in a room to another might be input by the user. As another example, the cameras 203d might capture motion of the limbs of the user while those limbs are in frame, such as hand and/or arm gestures made by the user might be captured by the cameras 203d.

Detecting the input may comprise detecting user gestures. The computing device may detect, via one or more of the motion sensitive devices 203c, a user gesture. For example, the user might point, wave their arms, move one of their fingers, bend their elbows, or the like. The computing device may determine, based on a motion property of the user gesture, the input. Such motion properties might be a direction of the user gesture, a speed of the user gesture, an orientation of the user gesture, or the like. For example, for a volume control gesture, movement upward might signify turning volume up, whereas movement downward might signify turning volume down. As another example, a quick swipe by a user to the left might signify going back in a web browser, whereas a slow swipe by a user to the left might signify scrolling horizontally to the left. The particular meaning of any given gesture might be determined by using motion properties of a user gesture to query a database. For example, a database might store a plurality of actions which correspond to different user gestures and for different applications, and the database might be queried using the motion properties to identify a particular user gesture.

Detecting the input may comprise detecting interaction with virtual objects. The computing device may present, in the XR environment, a representation of the display device. For example, as indicated above, a three-dimensional virtual display device may be displayed in the XR environment, and that three-dimensional virtual display device may be configured to display content that is displayed by a real-world display device (as captured by the cameras 203d). The computing device may then receive, in the XR environment, an interaction with the representation of the display device. For example, the user might look at the representation of the display device and perform a gesture, such as pointing at a particular portion of the representation of the display device. Then, the computing device may determine, based on the interaction, the input. Returning to the prior example, pointing to a portion of the representation of the display device might be indicative of a mouse click on a particular portion of a real-world display device.

As part of detecting the input, the XR environment might provide virtual interface elements that correspond to interface elements displayed by display devices. The computing device may determine one or more user interface elements in the content. For example, the content displayed by a real-world display device might comprise various buttons (e.g., “back” in a web browser, “play” in a media player), input fields (e.g., a text entry field), sliders (e.g., a volume control slider), or the like. The computing device may then present, in the XR environment and based on the one or more user interface elements, one or more virtual interface elements. For example, buttons might be represented in the XR environment as three-dimensional large push-buttons which the user might be able to push. As another example, an input field might be represented in the XR environment as a typewriter with a large keyboard such that the user might be able to push the keys of the keyboard to input text. As yet another example, sliders might be represented in the XR environment as large physical sliders such that the user might grab and pull the slider in various directions. The computing device may then receive, in the XR environment and via the one or more virtual interface elements, the input. In this manner, the user might be more easily interact with user interface elements in a real-world display. After all, absent replacement of real-world user interface elements with virtual user interface elements, it might be prohibitively difficult for a user to interact with the real-world user interface elements while in the XR environment.

In step 507, the computing device may determine whether the input received in step 506 is associated with at least one of the display devices detected in step 503. If the input received is not associated with at least one of the display devices detected in step 503, then the method 500 proceeds to step 510. Otherwise, if the input received is associated with at least one of the display devices detected in step 503, then the method 500 proceeds to step 508.

Determining whether the input received in step 506 is associated with at least one of the display devices detected in step 503 may be based on the gaze of the user. For example, input might be determined to be for a particular display device if a user is looking at the particular display device while performing the gesture. As another example, input might be determined to be for a particular display device if the gesture points towards the particular display device. A user might manually select a display device with which they want to interact. For example, the XR environment might provide a user a virtual switch that allows the user to switch between interacting with content displayed by the first monitor 401 and the second monitor 402.

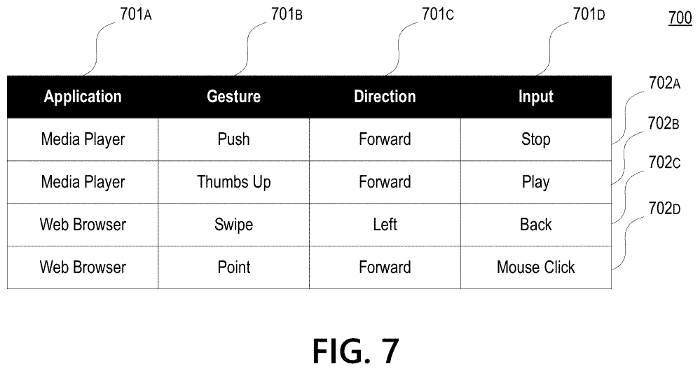

In step 508, the computing device may translate the input received in step 506. Because the input received in the XR environment might be gesture input, the input might need to be translated into corresponding input for the content displayed by a particular display device. For example, the television 403 might only accept input from a remote control, such that gesture input may be translated into a particular infrared transmission (e.g., the signal for “change channel,” “power on,” etc.). As another example, the laptop screen 404 might display a video game that is configured for gamepad input, such that gestures by a user (e.g., leaning left) are translated into gamepad input (e.g., pressing leftward on a joystick). An example of a database which might be used to translate such input is discussed below with respect to FIG. 7.

In step 509, the computing device may transmit the input to a corresponding computing device. As indicated with respect to FIG. 4, the various display devices may display content output from various different computing devices. As such, the computing device may identify a second computing device that causes content to be output on a display device (e.g., the display device associated with the input received in step 506), and send data corresponding to the input (e.g., once translated in step 508) to the second computing device. The second computing device need not necessarily know that the input it is sent is from an XR device. For example, the input might be sent, via infrared, to a set-top box managing output of video content on the television 403, such that the set-top box might not necessarily know that the input was received from the XR device 202 (rather than, for example, a remote control).

The corresponding computing device to which the input may be sent may be the same or different from the external computing device 204. The corresponding computing device may provide all or portions of the XR environment. For example, where the XR device 202 is a tethered XR device that relies on the graphics processing capabilities of the external computing device 204 to provide an XR environment, if the external computing device 204 also displays content on a monitor, then the corresponding computing device may be the external computing device 204. Additionally and/or alternatively, the corresponding computing device may be an entirely different computing device, such as a set-top box, a laptop, or the like.

Transmitting the input may comprise transmitting the input for a particular display device of a plurality of display devices. As indicated above, there may be a plurality of different display devices in the physical environment about the XR device 202, as is depicted in FIG. 4. The computing device may detect a plurality of display devices in the one or more images. The computing device may then select, based on the input, one of the plurality of display device. Then, the computing device may transmit, to the second computing device, instructions that cause the input to be associated with a portion of the content displayed by the selected one of the plurality of display devices.

In step 510, the computing device may determine whether the XR environment has ended. In effect, step 510 might operate a loop such that, while the XR environment is presented to a user, the system awaits further input and determines whether it is intended for one or more display devices. Along those lines, if the XR environment has not yet ended, the method 500 returns to step 506. Otherwise, the method 500 ends.

FIG. 6 depicts a bounding box 601 for the second monitor 402, which is shown displaying video content. FIG. 6 illustrates one way in which a bounding box might be drawn over content displayed by the second monitor 402. In this example, because content is being displayed only on the left portions of the second monitor 402 (and no content is being displayed on the right portion of the second monitor 402), the bounding box has been drawn around the content itself, rather than around the entirety of the display device. In this way, processing resources might be conserved. Additionally and/or alternatively, if content was drawn on the entirety of the second monitor 402, the bounding box might be displayed as bounding the entirety of the second monitor 402.

FIG. 7 depicts a table in a database 700 that indicates correlations between gestures in an XR environment and inputs for different applications. The data depicted in FIG. 7 might be used as part of step 508 of FIG. 5. The table shown in FIG. 7 has four columns: an application column 701a, a gesture column 701b, a direction column 701c, and an input column 701d. The application column 701a indicates an application, executing on a second computing device, which might be controlled by the user while the user is in the XR environment. The gesture column 701b corresponds to various gestures which might be performed by the user in the XR environment and, e.g., using the motion sensitive devices 203c. The direction column 701c corresponds to a direction of the gesture made by the user in the XR environment. The input column 701d corresponds to an input, for the application indicated in the application column 701a, that corresponds to the gesture.

The first row 702a indicates that a user might, in the XR environment, use a forward pushing gesture to provide a stop command to a media player. The second row 702b indicates that a user might, in the XR environment, use a thumbs up gesture in a forward motion to provide a play command to a media player. The third row 702c indicates that a user might, in the XR environment, swipe left to go back in a web browser application. The fourth row 702d indicates that a user might, in the XR environment, use a forward pointing gesture to cause a mouse click in a web browser application.

Though FIG. 7 depicts gestures as being application-specific for the purposes of illustration, such gestures need not be application-specific. For example, a gesture such as a user clapping their hands might be configured to always open a particular menu. As another example, a gesture such as a leftward swipe of the user's left hand might always be associated with a command to go back.

The following paragraphs (M1) through (M7) describe examples of methods that may be implemented in accordance with the present disclosure.

(M1) A method comprising sending, by a computing device and to an extended reality (XR) device, XR environment information for display of an XR environment on a display of the XR device; receiving, by the computing device, one or more images originating from one or more cameras of the XR device; detecting, by the computing device, one or more portions of a display device depicted in the one or more images, wherein the display device displays content from a second computing device; detecting, by the computing device, input, in the XR environment, associated with the content; and transmitting, by the computing device and to the second computing device, the input.

(M2) A method may be performed as described in paragraph (M1) wherein detecting the one or more portions of the display device depicted in the one or more images comprises: detecting, based on the one or more images, a bounding box corresponding to a location, in the one or more images, of the display device.

(M3) A method may be performed as described in paragraph (M1) or (M2) wherein detecting the one or more portions of the display device depicted in the one or more images comprises: providing, to a trained machine learning model, the one or more images, wherein the trained machine learning model has been trained using training data that indicates locations of display devices in a plurality of different images; and receiving, from the trained machine learning model, an indication of a predicted location of the display device.

(M4) A method may be performed as described in any one of paragraphs (M1)-(M3) wherein detecting the input comprises: detecting, via a motion sensitive device, a user gesture; and determining, based on a motion property of the user gesture, the input.

(M5) A method may be performed as described in any one of paragraphs (M1)-(M4) wherein detecting the input comprises: presenting, in the XR environment, a representation of the display device; receiving, in the XR environment, an interaction with the representation of the display device; and determining, based on the interaction, the input.

(M6) A method may be performed as described in any one of paragraphs (M1)-(M5) wherein detecting the input comprises: determining one or more user interface elements in the content; presenting, in the XR environment and based on the one or more user interface elements, one or more virtual interface elements; and receiving, in the XR environment and via the one or more virtual interface elements, the input.

(M7) A method may be performed as described in any one of paragraphs (M1)-(M6) wherein transmitting the input comprises: detecting a plurality of display devices in the one or more images; selecting, based on the input, one of the plurality of display devices; and transmitting, to the second computing device, instructions that cause the input to be associated with a portion of the content displayed by the selected one of the plurality of display devices.

The following paragraphs (A1) through (A7) describe examples of apparatuses that may be implemented in accordance with the present disclosure.

(A1) A computing device comprising: one or more processors; and memory storing instructions that, when executed by the one or more processors, cause the computing device to: send, to an extended reality (XR) device, XR environment information for display of an XR environment on a display of the XR device; receive one or more images originating from one or more cameras of the XR device; detect one or more portions of a display device depicted in the one or more images, wherein the display device displays content from a second computing device; detect input, in the XR environment, associated with the content; and transmit, to the second computing device, the input.

(A2) An apparatus as described in paragraph (A1), wherein the instructions, when executed by the one or more processors, further cause the computing device to detect the one or more portions of the display device depicted in the one or more images by causing the computing device to: detect, based on the one or more images, a bounding box corresponding to a location, in the one or more images, of the display device.

(A3) An apparatus as described in paragraph (A1) or (A2), wherein the instructions, when executed by the one or more processors, further cause the computing device to detect the one or more portions of the display device depicted in the one or more images by causing the computing device to: provide, to a trained machine learning model, the one or more images, wherein the trained machine learning model has been trained using training data that indicates locations of display devices in a plurality of different images; and receive, from the trained machine learning model, an indication of a predicted location of the display device.

(A4) An apparatus as described in any one of paragraphs (A1)-(A3), wherein the instructions, when executed by the one or more processors, further cause the computing device to detect the input by causing the computing device to: detect, via a motion sensitive device, a user gesture; and determine, based on a motion property of the user gesture, the input.

(A5) An apparatus as described in any one of paragraphs (A1)-(A4), wherein the instructions, when executed by the one or more processors, further cause the computing device to detect the input by causing the computing device to: present, in the XR environment, a representation of the display device; receive, in the XR environment, an interaction with the representation of the display device; and determine, based on the interaction, the input.

(A6) An apparatus as described in any one of paragraphs (A1)-(A5), wherein the instructions, when executed by the one or more processors, further cause the computing device to detect the input by causing the computing device to: determine one or more user interface elements in the content; present, in the XR environment and based on the one or more user interface elements, one or more virtual interface elements; and receive, in the XR environment and via the one or more virtual interface elements, the input.

(A7) An apparatus as described in any one of paragraphs (A1)-(A6), wherein the instructions, when executed by the one or more processors, further cause the computing device to transmit the input by causing the computing device to: detect a plurality of display devices in the one or more images; select, based on the input, one of the plurality of display devices; and transmit, to the second computing device, instructions that cause the input to be associated with a portion of the content displayed by the selected one of the plurality of display devices.

The following paragraphs (CRM1) through (CRM7) describe examples of computer-readable media that may be implemented in accordance with the present disclosure.

(CRM1) One or more non-transitory computer-readable media storing instructions that, when executed, cause a computing device to perform steps comprising: sending, by a computing device and to an extended reality (XR) device, XR environment information for display of an XR environment on a display of the XR device; receiving, by the computing device, one or more images originating from one or more cameras of the XR device; detecting, by the computing device, one or more portions of a display device depicted in the one or more images, wherein the display device displays content from a second computing device; detecting, by the computing device, input, in the XR environment, associated with the content; and transmitting, by the computing device and to the second computing device, the input.

(CRM2) The non-transitory computer-readable media as described in paragraph (CRM1), wherein the instructions, when executed, cause the computing device to perform the detecting the one or more portions of the display device depicted in the one or more images by causing the computing device to perform steps comprising: detecting, based on the one or more images, a bounding box corresponding to a location, in the one or more images, of the display device.

(CRM3) The non-transitory computer-readable media as described in paragraph (CRM1) or (CRM2), wherein the instructions, when executed, cause the computing device to perform the detecting the one or more portions of the display device depicted in the one or more images by causing the computing device to perform steps comprising: providing, to a trained machine learning model, the one or more images, wherein the trained machine learning model has been trained using training data that indicates locations of display devices in a plurality of different images; and receiving, from the trained machine learning model, an indication of a predicted location of the display device.

(CRM4) The non-transitory computer-readable media as described in any one of paragraphs (CRM1)-(CRM3), wherein the instructions, when executed, cause the computing device to perform the detecting the input by causing the computing device to perform steps comprising: detecting, via a motion sensitive device, a user gesture; and determining, based on a motion property of the user gesture, the input.

(CRM5) The non-transitory computer-readable media as described in any one of paragraphs (CRM1)-(CRM4), wherein the instructions, when executed, cause the computing device to perform the detecting the input by causing the computing device to perform steps comprising: presenting, in the XR environment, a representation of the display device; receiving, in the XR environment, an interaction with the representation of the display device; and determining, based on the interaction, the input.

(CRM6) The non-transitory computer-readable media as described in any one of paragraphs (CRM1)-(CRM5), wherein the instructions, when executed, cause the computing device to perform the detecting the input by causing the computing device to perform steps comprising: determining one or more user interface elements in the content; presenting, in the XR environment and based on the one or more user interface elements, one or more virtual interface elements; and receiving, in the XR environment and via the one or more virtual interface elements, the input.

(CRM7) The non-transitory computer-readable media as described in any one of paragraphs (CRM1)-(CRM6), wherein the instructions, when executed, cause the computing device to transmit the input by causing the computing device to: detect a plurality of display devices in the one or more images; select, based on the input, one of the plurality of display devices; and transmit, to the second computing device, instructions that cause the input to be associated with a portion of the content displayed by the selected one of the plurality of display devices.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

1. A computing device comprising:
one or more processors; and
memory storing instructions that, when executed by the one or more processors, cause the computing device to:
send, to an extended reality (XR) device, XR environment information for display of an XR environment on a display of the XR device;
receive one or more images originating from one or more cameras of the XR device;
detect one or more portions of a display device depicted in the one or more images, wherein the display device displays content from a second computing device;
provide, in the XR environment and based on identifying the content based on the one or more images;
a reproduction of at least a portion of the content from the second computing device; and
at least one user interface element configured to permit a user to interact; in the XR environment with the content displayed by the display device;
detect input, in the XR environment, that corresponds to an interaction with the at least one user interface element; and
cause the second computing device to modify display of the content on the display device by transmitting, to the second computing device, the input.

2. The computing device of claim 1, wherein the instructions, when executed by the one or more processors, further cause the computing device to detect the one or more portions of the display device depicted in the one or more images by causing the computing device to:
detect, based on the one or more images, a bounding box corresponding to a location, in the one or more images, of the display device.

3. The computing device of claim 1, wherein the instructions, when executed by the one or more processors, further cause the computing device to detect the one or more portions of the display device depicted in the one or more images by causing the computing device to:
provide, to a trained machine learning model, the one or more images, wherein the trained machine learning model has been trained using training data that indicates locations of display devices in a plurality of different images; and
receive, from the trained machine learning model, an indication of a predicted location of the display device.

4. The computing device of claim 1, wherein the instructions, when executed by the one or more processors, further cause the computing device to detect the input by causing the computing device to:
detect, via a motion sensitive device, a user gesture; and
determine, based on a motion property of the user gesture, the input.

5. The computing device of claim 1, wherein the instructions, when executed by the one or more processors, further cause the computing device to detect the input by causing the computing device to:
present, in the XR environment, a representation of the display device;
receive, in the XR environment, an interaction with the representation of the display device; and
determine, based on the interaction, the input.

6. The computing device of claim 1, wherein the instructions, when executed by the one or more processors, further cause the computing device to detect the input by causing the computing device to:
determine one or more user interface elements in the content;
present, in the XR environment and based on the one or more user interface elements, one or more virtual interface elements; and
receive, in the XR environment and via the one or more virtual interface elements, the input.

7. The computing device of claim 1, wherein the instructions, when executed by the one or more processors, further cause the computing device to transmit the input by causing the computing device to:
detect a plurality of display devices in the one or more images;
select, based on the input, one of the plurality of display devices; and
transmit, to the second computing device, instructions that cause the input to be associated with a portion of the content displayed by the selected one of the plurality of display devices.

8. A method comprising:
sending, by a computing device and to an extended reality (XR) device, XR environment information for display of an XR environment on a display of the XR device;
receiving, by the computing device, one or more images originating from one or more cameras of the XR device;
detecting, by the computing device, one or more portions of a display device depicted in the one or more images, wherein the display device displays content from a second computing device;
providing, in the XR environment and based on identifying the content based on the one or more images;
a reproduction of at least a portion of the content from the second computing device; and
at least one user interface element configured to permit a user to interact, in the XR environment, with the content displayed by the display device;
detecting, by the computing device, input, in the XR environment, that corresponds to an interaction with the at least one user interface element; and
causing the second computing device to modify display of the content on the display device by transmitting, by the computing device and to the second computing device, the input.

9. The method of claim 8, wherein detecting the one or more portions of the display device depicted in the one or more images comprises:
detecting, based on the one or more images, a bounding box corresponding to a location, in the one or more images, of the display device.

10. The method of claim 8, wherein detecting the one or more portions of the display device depicted in the one or more images comprises:
providing, to a trained machine learning model, the one or more images, wherein the trained machine learning model has been trained using training data that indicates locations of display devices in a plurality of different images; and
receiving, from the trained machine learning model, an indication of a predicted location of the display device.

11. The method of claim 8, wherein detecting the input comprises:
detecting, via a motion sensitive device, a user gesture; and
determining, based on a motion property of the user gesture, the input.

12. The method of claim 8, wherein detecting the input comprises:
presenting, in the XR environment, a representation of the display device;
receiving, in the XR environment, an interaction with the representation of the display device; and
determining, based on the interaction, the input.

13. The method of claim 8, wherein detecting the input comprises:
determining one or more user interface elements in the content;
presenting, in the XR environment and based on the one or more user interface elements, one or more virtual interface elements; and
receiving, in the XR environment and via the one or more virtual interface elements, the input.

14. The method of claim 8, wherein transmitting the input comprises:
detecting a plurality of display devices in the one or more images;
selecting, based on the input, one of the plurality of display devices; and
transmitting, to the second computing device, instructions that cause the input to be associated with a portion of the content displayed by the selected one of the plurality of display devices.

15. One or more non-transitory computer-readable media storing instructions that, when executed, cause a computing device to perform steps comprising:
sending, by a computing device and to an extended reality (XR) device, XR environment information for display of an XR environment on a display of the XR device;
receiving, by the computing device, one or more images originating from one or more cameras of the XR device;
detecting, by the computing device, one or more portions of a display device depicted in the one or more images, wherein the display device displays content from a second computing device;
providing, in the XR environment and based on identifying the content based on the one or more images;
a reproduction of at least a portion of the content from the second computing device; and
at least one user interface element configured to permit a user to interact, in the environment, with the content displayed by the display device;
detecting, by the computing device, input, in the XR environment, that corresponds to an interaction with the at least one user interface element; and
causing the second computing device to modify display of the content on the display device by transmitting, by the computing device and to the second computing device, the input.

16. The computer-readable media of claim 15, wherein the instructions, when executed, cause the computing device to perform the detecting the one or more portions of the display device depicted in the one or more images by causing the computing device to perform steps comprising:
detecting, based on the one or more images, a bounding box corresponding to a location, in the one or more images, of the display device.

17. The computer-readable media of claim 15, wherein the instructions, when executed, cause the computing device to perform the detecting the one or more portions of the display device depicted in the one or more images by causing the computing device to perform steps comprising:
providing, to a trained machine learning model, the one or more images, wherein the trained machine learning model has been trained using training data that indicates locations of display devices in a plurality of different images; and
receiving, from the trained machine learning model, an indication of a predicted location of the display device.

18. The computer-readable media of claim 15, wherein the instructions, when executed, cause the computing device to perform the detecting the input by causing the computing device to perform steps comprising:
detecting, via a motion sensitive device, a user gesture; and
determining, based on a motion property of the user gesture, the input.

19. The computer-readable media of claim 15, wherein the instructions, when executed, cause the computing device to perform the detecting the input by causing the computing device to perform steps comprising:
presenting, in the XR environment, a representation of the display device;
receiving, in the XR environment, an interaction with the representation of the display device; and
determining, based on the interaction, the input.

20. The computer-readable media of claim 15, wherein the instructions, when executed, cause the computing device to perform the detecting the input by causing the computing device to perform steps comprising:
determining one or more user interface elements in the content;
presenting, in the XR environment and based on the one or more user interface elements, one or more virtual interface elements; and
receiving, in the XR environment and via the one or more virtual interface elements, the input.
